(19) United States
(12) Patent Application Publication
(10) Pub. No.: US 2013/0165828 A1
(43) Pub. Date: Jun. 27, 2013

(54) CLEANING DEVICE, WITH FAUCET ADAPTER, FOR CLEANING TEETH AND MOUTH

(71) Applicant: S2L, LLC, Great Falls, VA (US)

(72) Inventor: John P. Sullivan, Frankfort, IL (US)

(73) Assignee: S2L, LLC, Great Falls, VA (US)

(21) Appl. No.: 13/718,038

(22) Filed: Dec. 18, 2012

Related U.S. Application Data
(60) Provisional application No. 61/578,544, filed on Dec. 21, 2011.

(51) Int. Cl. A61C 17/16

(52) U.S. Cl. CPC A61C 17/16
USPC 601/165

(57) ABSTRACT

A flossing device that includes a faucet adapter, by which the flossing device connects to an ordinary sink faucet.

### FIELD OF THE INVENTION

The present invention pertains to the field of dental hygiene devices, and more specifically to the field of irrigating dental cleaning devices.

### BACKGROUND OF THE INVENTION

A few years ago, when the Office of the Surgeon General released its first ever report on oral health, the most common chronic childhood disease by far in the United States was reported to be tooth decay. Children lose 512 million school hours a year due to dental related illness. Adults also suffer from various forms of dental disease and these complications can lead to painful oral surgery and costly trips to the dentist. Nationwide, health expenditures for dental services exceeded $60 billion in 2007.

The American Dental Association (“ADA”) recommends that teeth should be brushed at least twice daily, preferably after meals. In addition to brushing, daily flossing has been the prescription for healthy teeth and gums offered by dental hygienists for over 80 years. However, according to an ADA survey, only 5% of adults floss daily. The American Academy of Periodontology lists many excuses offered for the lack of flossing, from bleeding gums to dexterity difficulties to the time-consuming nature of the practice.

The patent literature includes:

U.S. Pat. No. 3,731,675 issued May 8, 1973 to James J. Kelly, for “Dental Cleaning Apparatus”;

U.S. Pat. No. 4,237,574 issued Dec. 9, 1980 to Kelly et al., for “Tooth Cleaning Apparatus.”

U.S. Pat. No. 4,793,331 issued Dec. 27, 1988 to Stewart, for “Shower Flossing System.”

U.S. Pat. No. 5,104,315 issued Apr. 14, 1992 to McKinley for “Oral Hygiene Device.”

U.S. Pat. No. 5,095,893 issued Mar. 17, 1992 to Rawden, Jr., for “Faucet Connected Oral Cleaning Device with Pulsating Flow.”

U.S. Pat. No. 5,387,182 issued Feb. 7, 1995 to Otani for “Faucet Mounted Water Jet Dental Hygiene Apparatus.”

U.S. Pat. No. 5,484,281 issued Jan. 16, 1996 to Renow et al., for “Showerhead Tooth Cleansing Apparatus.”

U.S. Pat. No. 6,152,733 issued Nov. 28, 2000 to Kenneth H. Hegemann, et al., for “Automated hands free oral cleansing device with bite block and computer control”;

U.S. Pat. No. 6,305,617 issued Oct. 23, 2001 to Yu for “Oscillating Disk Dental Hygiene Device.”

U.S. Pat. No. 6,893,259 issued May 17, 2005, to Igor Reizenson for “Oral hygiene device . . . ”;

U.S. Pat. No. 7,059,853 issued Jun. 13, 2006 to Hegemann (assigned to CRA Labs, Inc.), for “Oral Irrigation and/or Brushing Devices and/or Methods.”

US Patent Publication 2011/0027746 published Feb. 3, 2011 by McDonogh et al. (Johnson & Johnson), for “Oral Care Device.”

US Patent Publication 2011/0027748 published Feb. 3, 2011 by Fusi, II et al. (Johnson & Johnson), for “Oral Care Systems.”

US Patent Publication 2011/0027747 published Feb. 3, 2011 by Fougere et al. (Johnson & Johnson), for “Oral Care Device.”

However, despite all this work to date, there remains a need for simpler, easier to use cleaning devices in various contexts, such as, for example, that of a care giver caring for someone who has physical limitations that interfere with performance of one's own daily dental routine.

### SUMMARY OF THE INVENTION

It is an object of the present invention to provide an irrigating dental cleaning device, especially, a flossing device.

The invention in one preferred embodiment provides a flossing device comprising: a faucet adapter (such as, e.g., an L-shaped faucet adapter; a faucet adapter that comprises: a circular opening into which is received a faucet; a hollow space through which water from the faucet flows; and a set of exit channels (such as, e.g., a set of three exit channels)); a mouthpiece (such as, e.g., a U-shaped mouthpiece which conforms to teeth within a mouth of a wearer of the mouthpiece); and multiple hoses (such as, e.g., three hoses) each hose having a first end connected to the faucet adapter and a second end connected to the mouthpiece; such as, e.g., inventive devices wherein the multiple hoses comprise a hose through which clean water travels from the faucet adapter into the mouthpiece, and further comprising a mouthwash container (such as, e.g., a mouthwash container that contains a quantity of mouthwash; a mouthwash container that comprises a screw-top cap screwed onto a cup section; etc.), wherein the mouthwash container is connected to the hose through which clean water travels such that contents of the mouthwash container are received into the hose and travel with the clean water towards the mouthpiece; etc.

### BRIEF DESCRIPTION OF THE DRAWINGS

FIGS. 1-3 depict a first exemplary embodiment of a device according to the present invention, as follows:

FIG. 1 is a perspective view of an inventive device that can be connected to an ordinary faucet;

FIG. 2 is a perspective view of an inventive flossing device in an embodiment;

FIG. 3 is a cross-section view of a faucet adapter used in the invention.

### DETAILED DESCRIPTION OF A PREFERRED EMBODIMENT OF THE INVENTION

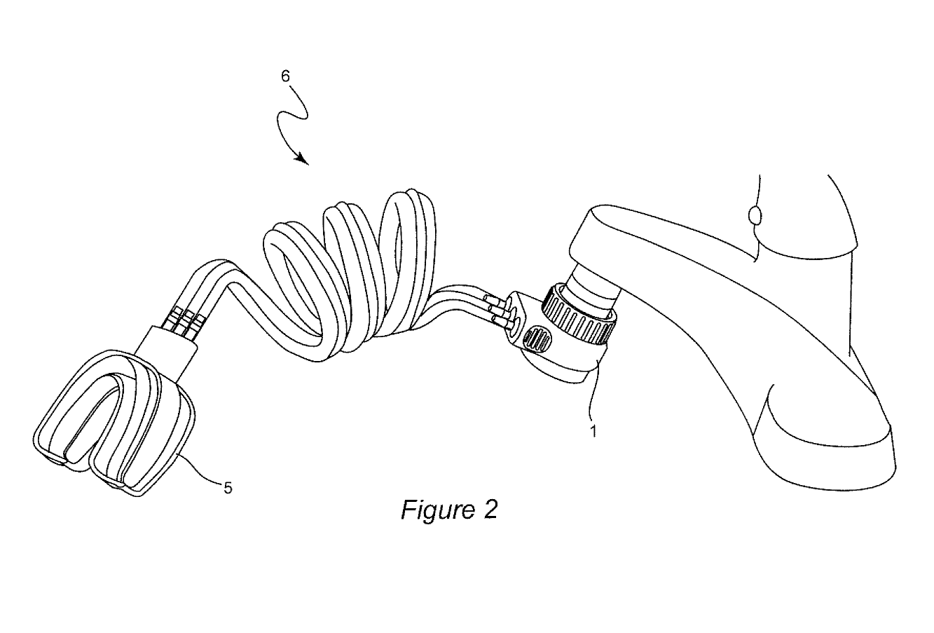

The present invention provides a device which may be called, e.g., a mouth-cleaning device or a flossing device. By “flossing”, we refer to the generalized dislodging of particles between teeth, and not to use of dental floss in string form. An exemplary inventive cleaning method is performed by a device (such as, e.g., the flossing device 6 in FIG. 2) that connects to a standard water faucet, after the device has been connected to the water faucet.

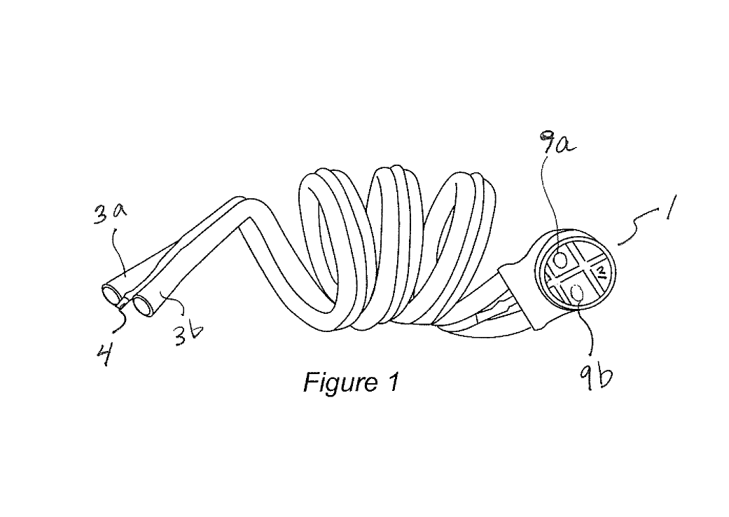

The invention provides for managing water flow in a flossing device including channeling clean water from a standard faucet and disposing of used water. Preferably both the channeling of the clean water and the disposing of used water are performed by a faucet adapter, such as, e.g., faucet adapter 1 in FIGS. 1-2. Faucet adapter 1 has an open top section that when screwed onto a standard faucet is tightly sealed, a bottom section 2 from which clean water does not exit; clean water from the faucet can only exit the faucet adapter 1 through a tube for outgoing clean water, headed towards the mouthpiece. Dirty water that exits the mouthpiece 5 is received into a tube that carries the dirty water back towards the faucet adapter 1 where the dirty water is directed downwards out of the faucet adapter 1 and into the sink basin.

A preferred example of how tubes are used to channel water is a set of three tubes, also called hoses, such as outer hoses 3a, 3b and middle hose 4. Preferably the three hoses 3a, 3b, 4 are the same diameter, with the clean water being carried by the middle hose 4 and the dirty water being carried by the outer hoses 3a, 3b.

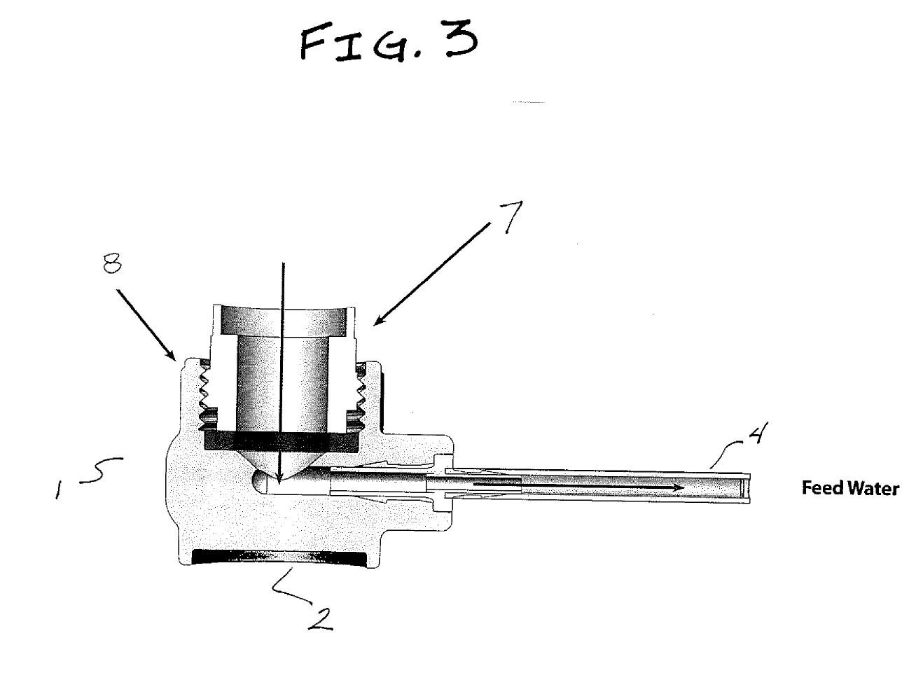

An example of channeling clean water (feed water) is depicted in FIG. 3, wherein clean water exits the faucet adapter 1 via hose 4. Faucet adapter 1 comprises component 8 including ¾″ female GHT (Garden Hose Thread standard). Faucet adapter 1 comprises a component 7 including male 15/16″-27 UNS-2B and female 55/64″-27 UNS-2B×Male ¾″ CHT an Male 55/64″-27 USN-2B. (90% of North American households have a ‘Regular’ sized thread for aerators: Regular male: 15/16″-27 UNS-2B; Regular female: 55/64″-27 UNS-2B.)

Preferably the Male ¾″ thread on the water manifold is replaced with a Female ¾″ thread to accept more universal adapters and quick-disconnect products.

Preferably the bottom 2 of the faucet adapter 1 has added ribs for structure and also to guide more of the water downward.

Dirty water is ejected out of the device 6 via at least one dump hole, preferably out of the bottom of the faucet adapter 1, such as out of dump holes 9a, 9b. Preferably dump holes 9a, 9b have about the same size and shape as the tubes 3a, 3b. The placement of dump holes 9a, 9b in FIG. 1 is only for illustration purposes and the placement of the dump holes is not particularly limited. The dump holes are not required to be in bottom face 2 and could be elsewhere in device 6. Preferably an inventive device is constructed so that dirty water enters the faucet adapter inside tubing and then is angled downwards to exit out the bottom of the faucet adapter, preferably out of two dump holes similarly sized and shaped like the exit tubing.

In operation, clean water is received from the faucet into the device 6 via faucet adapter 1, wherein the faucet adapter snugly joins the device 6 to the faucet. Once the device 6 has been attached to the water faucet and the water faucet has been turned on manually, the device 6 itself performs a step of receiving clean water from the faucet into itself.

The clean water received into the device 6 is sent towards the mouthpiece, via hose 4 and from the hose into the device's mouthpiece. The clean water performs cleaning action within the mouthpiece, and becomes used water, after which the used water is received into a tube that returns to the adapter 1. A tube via which the used water travels is different than a tube via which the clean water travels. When the device 6 is connected to a standard water faucet, and when the water faucet is turned on and kept on for a period of time, clean water is ejected out of the device 6 into the mouth of a to-be-flossed individual by operation of the further clean water entering the mouthpiece behind the clean water that is being ejected. Preferably the mouthpiece includes a plurality of holes opening into the mouth and operation of device 6 includes ejecting the clean water from a plurality of holes in the mouthpiece. In order for the clean water ejected into the mouth to be pressurized enough to operate as intended within the mouth, preferably the water is ejected from a plurality of holes (openings) in the mouthpiece where the total of the cross-sectional surface areas of the respective holes (measured at the points where the clean water is ejected from the mouthpiece) is an amount that is smaller than the cross-sectional surface area of the device where the device receives the clean water from the faucet. When making the mouthpiece, the total number of the holes, and the cross-sectional area of the holes, is selected so that the clean water when being ejected is ejected under sufficient pressure to perform a cleaning operation.

When constructing a mouthpiece for use in human mouths, preferably each hole has a diameter in a range of between about 0.015 inch to 0.05 inch. If the hole is smaller than 0.015 inch, a mold-ability problem is presented when constructing the mouthpiece, and in use there may be a risk of back pressure. If the hole is bigger than 0.05 inch, there can be a problem with loss of pressure. Although we mention “diameter” herein for describing size, it should be appreciated that a hole is not required to be circular, and other shapes can be constructed, such as, e.g., rectangular, etc.

When constructing a mouthpiece for use in human mouths, preferably a number of holes is in a range of 58 to 72.

The device 6's ejecting the clean water into the mouth is followed by the clean water's action dislodging food particles. Namely, clean water that has been ejected out of the device 6 operates to dislodge food particles from between teeth. When the mouthpiece is constructed, preferably a pattern of the holes from which the clean water is ejected from the mouthpiece is selected to aim ejected clean water at gaps between teeth. However, it will be appreciated that individuals may have a variety of tooth spacing, such as due to having had orthodontic work or otherwise. Therefore preferably the mouthpiece is constructed so that when the mouthpiece is in use, the mouthpiece can be wiggled or moved somewhat during operation of the water delivery, as needed, so that pressurized water will be able to perform the dislodging.

After food particles have been thus dislodged, the device 6 gathers dirty water (including the food particles) back into the device's mouthpiece. To accomplish the dirty-water receiving, the mouthpiece is constructed to include at least one exit channel that is oriented in a direction of where the dirty water is in the mouth and that receives the dirty water from the mouth. After the device 6 receives the dirty water into the device's mouthpiece, next in normal operation of device 6 there occurs discharging of the dirty water out of the mouthpiece.

Advantageously operation of device 6 is practiced without any suction pump, and without any power source, being included in or attached to the device 6. Advantageously, the invention provides devices that connect to a standard faucet, and methods that can be practiced using a standard faucet.

When constructing an inventive flossing device 6, preferably a mouthpiece manifold is constructed using two polypropylene duplicate parts, sandwiched around a connector-collector part, and adhered (such as, e.g., sonically welded). Such an arrangement allows for varying sizes of the water jet delivery part (i.e., the two identical parts) to fit one connector-collector part.

When constructing a device according to the invention and for use in humans, it should be considered that different people have different-size bites. One way to accommodate all human mouth sizes is to design three distinct-sized mouthpieces (all sharing the same mouthpiece manifold part). Another approach is to construct a middle size in a lower durometer (softer) material which can flex to each mouth shape. However, use of a lower durometer material to construct the mouthpiece tends to produce a less-durable product, is also a more costly production methodology, and results in a product that is prone to allowing the water channels to get “pinched off.” Examples of materials useable for constructing the mouthpiece are, e.g., silicone; polypropylene; etc.

For transporting water within the device 6, such as the mouthpiece's receiving clean water, and the mouthpiece's discharging of the dirty water towards the sink, a suitable water-transportation part can be used, such as, e.g., one or more hoses, such as, e.g., a hose made of an ether-based polyurethane material, a hose that meets National Sanitation Foundation specifications (NSF-61), etc.

Examples of a hose's form are, e.g., straight, coiled, a combination thereof.

A preferred example of a hose length is in a range of about 6 to 36 inches. A 6-inch hose preferably would be used in straight form. A 36-inch hose preferably would be used in coiled form.

When constructing a device 6, design choices are preferred such that the water pressure is at least 50 psi (to maintain positive water-jet action in the mouthpiece) but not greater than 70 psi (to prevent manifold blowout which could cause damage to the mouthpiece).

In the invention, flow of water is managed to accomplish the cleaning objective without having water undesirably travel down the throat of someone in whom the device is being used, and without having water spurt out of the front of that person's mouth. Incoming water which is clean water from a faucet travels via an inlet nozzle which preferably is a central inlet nozzle, and moves through the inventive device 6.

A preferred water direction approach to use in constructing a device 6 according to the invention is to direct water (from the faucet) into, through, and out of the mouthpiece, which then collects waste water and directs the waste water to exit holes (preferably two exit holes).

In constructing the inventive device, a geometry is used that avoids water going into the throat of the person in whom it is used and that also avoids water spurting out of the front of the mouth. This can be accomplished, for example, by constructing a device based on assuming a same mouth action that keeps mouthwash contained in the mouth during a gargling procedure, such as, e.g., a device with a snorkel-style shape in front, a device with a bulging front that creates a sufficient seal at the front of the mouth, etc.

Optionally a mouthwash injector is included in an inventive apparatus.

The invention may be further appreciated with reference to the following examples below, without the invention being limited to the examples.

### Inventive Example 1

### Hydro Clean Auto Floss

The inventive device in this example comprises a molded mouth-guard type mouthpiece configured in a U shape to conform to the contours of a set of human teeth, having a trough to receive the teeth (while the teeth are within the mouth of the individual receiving the cleaning treatment), further comprising an irrigation water flow component at the front thereof consisting of an attachable tubing apparatus, allowing users to floss all of the teeth by means of pressurized water (not shown), at once, whether at home or on the go. The mouthpiece is molded into a one-size-fit-all model, facilitating a comfortable fit when placed into the mouth. A series of small circular openings are positioned along the perimeter of the mouthpiece, serving as the egress for water. The mouthpiece also features a force fit opening, which serves as the attachment point for the irrigation water flow component. The irrigation water flow component comprises one central inlet nozzle, and two outlet nozzles, positioned on each side of the inlet nozzle. All of these nozzles are designed to receive tubing by means of a force fit. The hose tubing is intended to be provided with the device. At the opposite end of the inlet hose is a spout adapter that is configured to accommodate most sink faucets.

### Inventive Example 1A

In this example, the device has a small compartment with a cap that is attached to the input line and is filled with mouthwash and squeezed into the input line. The device is packaged withing a durable plastic casing to protect the unit from airborne geniis and bacteria when not in use. Various embodiments are produced in a variety of attractive and eye catching colors, as well as various sizes to appeal to and accommodate both adults and children.

### Inventive Example 1B

### Use of the Device

To use the device of Example 1 or 1A, first the user places an encased unit on him- or herself before heading out on an intended activity. By way of example, a business executive slips a unit into his interior coat pocket on his way to work. As another example, a mother embarking on a shopping trip inserts a Hydro Clean Auto Floss system into her purse. After a meal, the user removes the unit from its packaging, and connects the hose to the part to be used in the mouth and to a sink faucet. After inserting the mouthpiece along the teeth, the water from the sink is channeled through the tube and into the mouth, with sufficient pressure that food particles are removed from between the teeth.

Using an inventive device, a user can accomplish flossing in record time, without needing to strangle their fingers with floss, and can more effectively accomplish the flossing task. In addition, the models offered by this versatile product line appeal to virtually any user, further encouraging both young and old to add flossing to their dental care regimen. Consumers appreciate that this product not only allows them to care for their dental health, but is also helpful for overall health and well-being. Not just restricted to household use, domestic and foreign travelers find the Hydro Clean Auto Floss especially convenient. Compact and lightweight, a package of this handy product is easily packed into any shaving kit, travel bag, or carry-on. Hotel guests also enjoy the convenience of the Hydro Clean Auto Floss which can be made available in hotel gift shops and at lobby desks. Offered along with forgotten toothpaste and brush, this provides hotel guests with a quick and sanitary oral solution while they are away from home.

The Hydro Clean Auto Floss is an innovative product invention helpful to increase the number of people who floss on a daily basis. Versatile and convenient, this product is a user-friendly approach to healthy oral hygiene and can be used by adults and children alike.

### Inventive Example 2

A device was constructed comprising a molded mouth-guard type mouthpiece intended to be used in a mouth and configured in a U shape to conform to the contours of a set of human teeth, having a trough to receive the teeth, further comprising an irrigation water flow component at the front thereof consisting of an attachable tubing apparatus, allowing users to floss all of the teeth by means of pressurized water, at once, whether at home or on the go. The mouthpiece is molded as a one size fits all model, facilitating a comfortable fit when placed into the mouth. A series of openings are positioned along the perimeter of the mouthpiece, serving as the egress for clean water being ejected from the mouthpiece. The mouthpiece also comprises a force fit opening, which serves as the attachment point for the irrigation water flow component to the mouthpiece. The irrigation water flow component comprises one central inlet nozzle, and two outlet nozzles, positioned on each side of the inlet nozzle. Nozzles are designed to receive tubing by means of a force fit.

The device includes a manifold and a pair of jet channels. The manifold is constructed to direct pressurized clean water through a collection of water jets to the gums of the mouth being cleaned, while also provided for controlled exit of the dirty water from the mouth to a waste drain. Preferably, manifold plumbs water inside of the manifold, while directing waste water along outside surfaces of the manifold to collection channels which have waste tubes attached.

The manifold is sandwiched between identical nozzles to create water and waste channels. The mouthpiece comprises an outlet, and an opening which deeper in the mouthpiece has a wider diameter. On the surface of the mouthpiece where the clean water is ejected from the device towards the teeth, the opening has a narrower diameter. Particularly, the mouthpiece is constructed with a slanted sidewall (such as a sidewall having a 55 degree slant) in connection with the opening. The slanted sidewall guides the clean water being ejected from the mouthpiece in an angled trajectory towards the to-be-cleaned parts of the mouth.

Angling of a water jet being ejected from the mouthpiece is created with particular geometry, particularly the slanted sidewall.

### Inventive Example 2A

A 55 degree sidewall is used for the slant of the slanted sidewall, because 55 degrees represents a mid-range for an effective range of water jet between 40 and 70 degrees (which is a range intended to teach below gums).

To create the 55 degree angle, preferably the jet is formed by a mold pulled directly up and down in regard to the horizontal. As a result, the constructed hole faces up at 90 degrees, yet the jet of clean water leaves the hole at 55 degrees.

### Inventive Example 2B

In a constructed prototype, the mouthpiece has openings that are water jets that are 0.015 inch by 0.040 inch rectangular slits.

### Inventive Example 2C

In a constructed prototype, the mouthpiece has 68 holes.

### Inventive Example 2D

In a constructed prototype, hoses made of an ether-based polyurethane material were used. The inner diameter of the inlet hose is 0.125 inch. The inner diameter of the exhaust tube is 0.25 inch. The hose length is 10 inches.

### Inventive Example 3

In another constructed prototype, a Mouthwash Injector was included, incorporating a container that contains a quantity of about 2 ounces of mouthwash, from which container mouthwash is sucked into the tube that transports clean water over a period of about 5-7 seconds, then is mixed with air. A foamy, bubbly sensation is provided into the mouth.

### Inventive Example 4

### Mouthwash Injector

In this example, a prototype was built in which a mouthwash injector was included. The container in which the mouthwash is contained is 2 oz. The mouthwash is sucked into the line (hose) in which clean water travels toward the mouthpiece. The time during which the mouthwash is sucked into the line (such as, e.g., sucking into the line over about 5 to 7 seconds), then is mixed with air a little bit, to give a foamy, bubbly sensation.

It should be appreciated that variations and modifications from the embodiments set forth above may be made without departing from the spirit of the invention, and that such modifications are to be considered within the present invention.

What we claim as our invention is:

1. A flossing device comprising:
a faucet adapter;
a mouthpiece; and
multiple hoses each hose having a first end connected to the faucet adapter and a second end connected to the mouthpiece.

2. The device of claim 1, including three hoses.

3. The device of claim 1, wherein the mouthpiece is a U-shaped mouthpiece which conforms to teeth within a mouth of a wearer of the mouthpiece.

4. The device of claim 1, wherein the faucet adapter comprises:
a circular opening into which is received a faucet;
a hollow space through which water from the faucet flows; and
a set of exit channels.

5. The device of claim 1, wherein the set of exit channels includes three exit channels.

6. The device of claim 1, wherein the faucet adapter is L-shaped.

7. The device of claim 1, wherein the multiple hoses comprise a hose through which clean water travels from the faucet adapter into the mouthpiece, and further comprising a mouthwash container, wherein the mouthwash container is connected to the hose through which clean water travels such that contents of the mouthwash container are received into the hose and travel with the clean water towards the mouthpiece.

8. The device of claim 7, wherein a quantity of mouthwash is contained in the mouthwash container.

9. The device of claim 7, wherein the mouthwash container comprises a screw-top cap screwed onto a cup section.
